(19) United States
(12) Patent Application Publication
(10) Pub. No.: US 2009/0092501 A1
(43) Pub. Date: Apr. 9, 2009

(54) COMPRESSOR PROTECTION SYSTEM AND METHOD

(75) Inventor: Stephen M. Seibel, Celina, OH (US)

Correspondence Address: HARNESS, DICKEY & PIERCE, P.L.C., P.O. BOX 828, BLOOMFIELD HILLS, MI, 48303, US

(73) Assignee: Emerson Climate Technologies, Inc., Sidney, OH (US)

(21) Appl. No.: 12/246,825

(22) Filed: Oct. 7, 2008

Related U.S. Application Data
(60) Provisional application No. 60/978,300, filed on Oct. 8, 2007.
(60) Provisional application No. 60/978,258, filed on Oct. 8, 2007.

(51) Int. Cl. F04B 49/06; G05B 15/00

(52) U.S. Cl. 417/44.1; 700/275

(57) ABSTRACT

A system and method for protecting a variable speed compressor may include an inverter drive that modulates a frequency of electric power delivered to the compressor to modulate a speed of the compressor. The inverter drive may be cooled by refrigerant and include a temperature sensor that outputs an inverter temperature signal corresponding to an inverter temperature. A control module may receives the inverter temperature signal, compare the inverter temperature with a predetermined threshold, and reduce a compressor operating speed range when the inverter temperature is greater than the predetermined threshold.

### CROSS-REFERENCE TO RELATED APPLICATIONS

This application claims the benefit of U.S. Provisional Application No. 60/978,300, filed on Oct. 8, 2008. This application also claims the benefit of U.S. Provisional Application No. 60/978,258, filed on Oct. 8, 2008. The entire disclosures of each of the above applications are incorporated herein by reference.

### FIELD

The present disclosure relates to compressors and more particularly to a compressor protection system and method.

### BACKGROUND

The statements in this section merely provide background information related to the present disclosure and may not constitute prior art.

Compressors may be used in a wide variety of industrial and residential applications to circulate refrigerant within a refrigeration, heat pump, HVAC, or chiller system (generically “refrigeration systems”) to provide a desired heating or cooling effect. In any of the foregoing applications, the compressor should provide consistent and efficient operation to insure that the particular application (i.e., refrigeration, heat pump, HVAC, or chiller system) functions properly. A variable speed compressor may be used to vary compressor capacity according to refrigeration system load. Operating parameters of the compressor and of the refrigeration system may be used by protection, control, and diagnostic systems to insure optimal operation of the compressor and refrigeration system components. For example, evaporator temperature and/or condenser temperature may be used to diagnose, protect, and control the compressor and other refrigeration system components.

### SUMMARY

A system is provided comprising a compressor and a control module. The compressor is driven by an inverter drive that modulates a frequency of electric power delivered to the compressor to modulate a speed of the compressor. The inverter drive is cooled by refrigerant and includes a temperature sensor that outputs an inverter temperature signal corresponding to an inverter temperature. The control module receives the inverter temperature signal, compares the inverter temperature with a predetermined threshold, and reduces a compressor operating speed range when the inverter temperature is greater than the predetermined threshold.

In other features, the control module increases a speed of a condenser fan of a condenser connected to the compressor when the inverter temperature is greater than the predetermined threshold.

In other features, the control module, after reducing the compressor operating speed range, increases the compressor operating speed range when the inverter temperature is less than the predetermined threshold.

In other features, the control module reduces the compressor operating speed range to an initial cooling capacity speed when the inverter temperature is greater than the predetermined threshold.

In other features, the control module returns the compressor to normal operation when the inverter temperature returns to a temperature below the predetermined threshold.

A method is provided comprising modulating a speed of a compressor with an inverter drive that modulates a frequency of electric power delivered to the compressor, the inverter drive being cooled by refrigerant, receiving an inverter temperature signal corresponding to a temperature of the inverter drive, comparing the temperature of the inverter drive with a predetermined threshold, and reducing a compressor operating speed range of the compressor when the temperature is greater than the threshold.

In other features, method may include increasing a speed of a condenser fan of a condenser connected to the compressor when the temperature of the inverter drive is greater than the threshold.

In other features, after reducing the compressor operating speed range, the method may include increasing the compressor operating speed range when the temperature is less than the threshold.

In other features, the reducing the compressor operating speed range may include reducing the compressor operating speed range to an initial cooling capacity speed when the temperature of the inverter drive is greater than the threshold.

In other features, the method may include returning the compressor to normal operation when the temperature of the inverter returns to a temperature below the predetermined threshold.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of a refrigeration system.

FIG. 2 is a perspective view of a compressor.

FIG. 3 is a perspective view of a compressor.

FIG. 4 is a flow chart illustrating steps performed by an algorithm according to the present teachings.

FIG. 5 is a graph showing discharge super heat correlated with suction super heat and outdoor temperature.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, the terms module, control module, and controller refer to one or more of the following: An application specific integrated circuit (ASIC), an electronic circuit, a processor (shared, dedicated, or group) and memory that execute one or more software or firmware programs, a combinational logic circuit, or other suitable components that provide the described functionality. As used herein, computer readable medium refers to any medium capable of storing data for a computer. Computer-readable medium includes, but is not limited to, memory, RAM, ROM, PROM, EPROM, EEPROM, flash memory, CD-ROM, floppy disk, magnetic tape, other magnetic medium, optical medium, or any other device or medium capable of storing data for a computer.

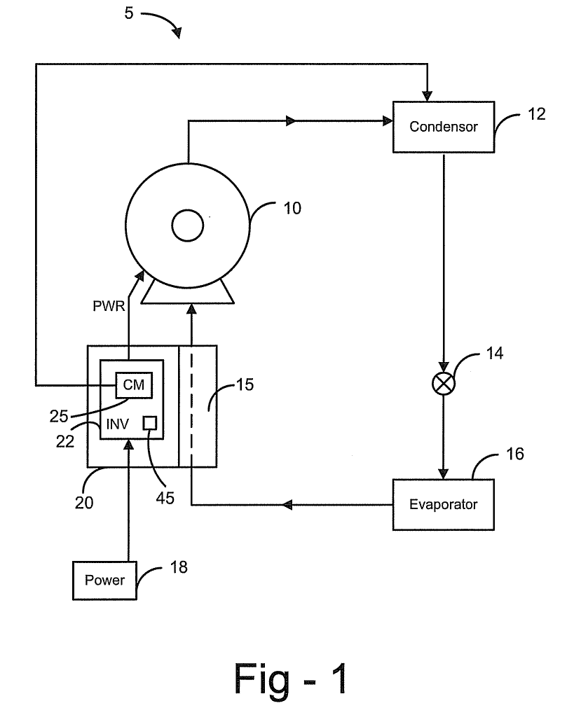

With reference to FIG. 1, an exemplary refrigeration system 5 includes a compressor 10 that compresses refrigerant vapor. While a specific refrigeration system is shown in FIG. 1, the present teachings are applicable to any refrigeration system, including heat pump, HVAC, and chiller systems. Refrigerant vapor from compressor 10 is delivered to a condenser 12 where the refrigerant vapor is liquefied at high pressure, thereby rejecting heat to the outside air. The liquid refrigerant exiting condenser 12 is delivered to an evaporator 16 through an expansion valve 14. Expansion valve 14 may be a mechanical or electronic valve for controlling super heat of the refrigerant. The refrigerant passes through expansion valve 14 where a pressure drop causes the high pressure liquid refrigerant to achieve a lower pressure combination of liquid and vapor. As hot air moves across evaporator 16, the low pressure liquid turns into gas, thereby removing heat from evaporator 16. The low pressure gas is again delivered to compressor 10 where it is compressed to a high pressure gas, and delivered to condenser 12 to start the refrigeration cycle again.

Compressor 10 may be driven by an inverter drive 22, also referred to as a variable frequency drive (VFD), housed in an enclosure 20. Enclosure 20 may be near compressor 10. Inverter drive 22 receives electrical power from a power supply 18 and delivers electrical power to compressor 10. Inverter drive 22 includes a control module 25 with a processor and software operable to modulate and control the frequency of electrical power delivered to an electric motor of compressor 10. Control module 25 includes a computer readable medium for storing data including the software executed by the processor to modulate and control the frequency of electrical power delivered to the electric motor of compressor and the software necessary for control module 25 to execute and perform the protection and control algorithms of the present teachings. By modulating the frequency of electrical power delivered to the electric motor of compressor 10, control module 25 may thereby modulate and control the speed, and consequently the capacity, of compressor 10.

Inverter drive 22 includes solid state electronics to modulate the frequency of electrical power. Generally, inverter drive 22 converts the inputted electrical power from AC to DC, and then converts the electrical power from DC back to AC at a desired frequency. For example, inverter drive 22 may directly rectify electrical power with a full-wave rectifier bridge. Inverter driver 22 may then chop the electrical power using insulated gate bipolar transistors (IGBT's) or thyristors to achieve the desired frequency. Other suitable electronic components may be used to modulate the frequency of electrical power from power supply 18.

Electric motor speed of compressor 10 is controlled by the frequency of electrical power received from inverter driver 22. For example, when compressor 10 is driven at sixty hertz electric power, compressor 10 may operate at full capacity operation. When compressor 10 is driven at thirty hertz electric power, compressor 10 may operate at half capacity operation.

Control module 25 may generate data corresponding to compressor current and/or compressor power during the routines executed to modulate the electric power delivered to the electric motor of compressor 10. Control module 25 may utilize data corresponding to compressor current and/or compressor power to calculate and derive other compressor and refrigeration system parameters.

As described in the disclosure titled “VARIABLE SPEED COMPRESSOR PROTECTION SYSTEM AND METHOD”, U.S. Application Ser. No. 60/978,258, which is incorporated herein by reference, suction super heat (SSH) and discharge super heat (DSH) may be used to monitor or predict a flood back condition or overheat condition of compressor 10. As described therein, condenser temperature (Tcond) may be used to derive DSH. Likewise, evaporator temperature (Tevap) may be used to derive SSH.

A compressor floodback or overheat condition is undesirable and may cause damage to compressor 10 or other refrigeration system components. Suction super heat (SSH) and/or discharge super heat (DSH) may be correlated to a flood back or overheating condition of compressor 10 and may be monitored to detect and/or predict a flood back or overheating condition of compressor 10. DSH is the difference between the temperature of refrigerant vapor leaving the compressor, referred to as discharge line temperature (DLT) and the saturated condenser temperature (Tcond). Suction super heat (SSH) is the difference between the temperature of refrigerant vapor entering the compressor, referred to as suction line temperature (SLT) and saturated evaporator temperature (Tevap).

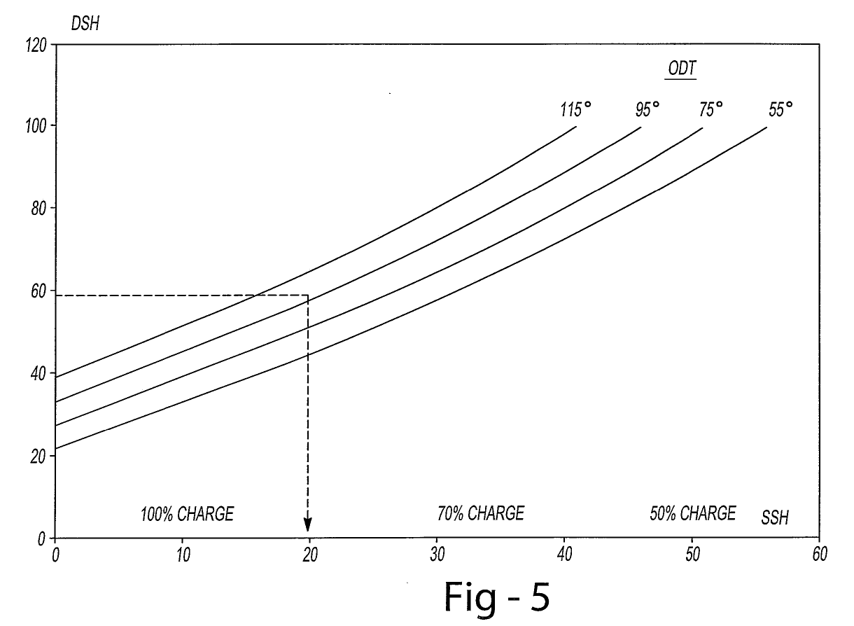

SSH and DSH may be correlated as shown in FIG. 5. The correlation between DSH and SSH may be particularly accurate for scroll type compressors, with outside ambient temperature being only a secondary effect. As shown in FIG. 5, correlations between DSH and SSH are shown for outdoor temperatures (ODT) of one-hundred fifteen degrees Fahrenheit, ninety-five degrees Fahrenheit, seventy-five degrees Fahrenheit, and fifty-five degrees Fahrenheit. The correlation shown in FIG. 5 is an example only and specific correlations for specific compressors may vary by compressor type, model, capacity, etc.

A flood back condition may occur when SSH is approaching zero degrees or when DSH is approaching twenty to forty degrees Fahrenheit. For this reason, DSH may be used to detect the onset of a flood back condition and its severity. When SSH is at zero degrees, SSH may not indicate the severity of the flood back condition. As the floodback condition becomes more severe, SSH remains at around zero degrees. When SSH is at zero degrees, however, DSH may be between twenty and forty degrees Fahrenheit and may more accurately indicate the severity of a flood back condition. When DSH is in the range of thirty degrees Fahrenheit to eighty degrees Fahrenheit, compressor 10 may operate within a normal range. When DSH is below thirty degrees Fahrenheit, the onset of a flood back condition may be occur. When DSH is below ten degrees Fahrenheit, a severe flood back condition may occur.

With respect to overheating, when DSH is greater than eighty degrees Fahrenheit, the onset of an overheating condition may occur. When DSH is greater than one-hundred degrees Fahrenheit, a severe overheating condition may be present.

In FIG. 5, typical SSH temperatures for exemplar refrigerant charge levels are shown. For example, as the percentage of refrigerant charge in refrigeration system 5 decreases, SSH typically increases.

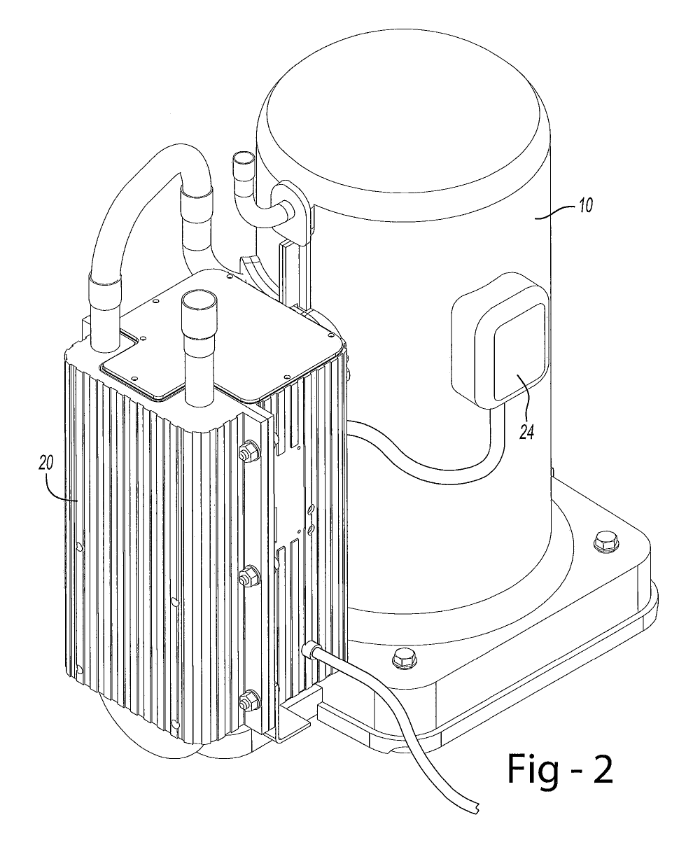

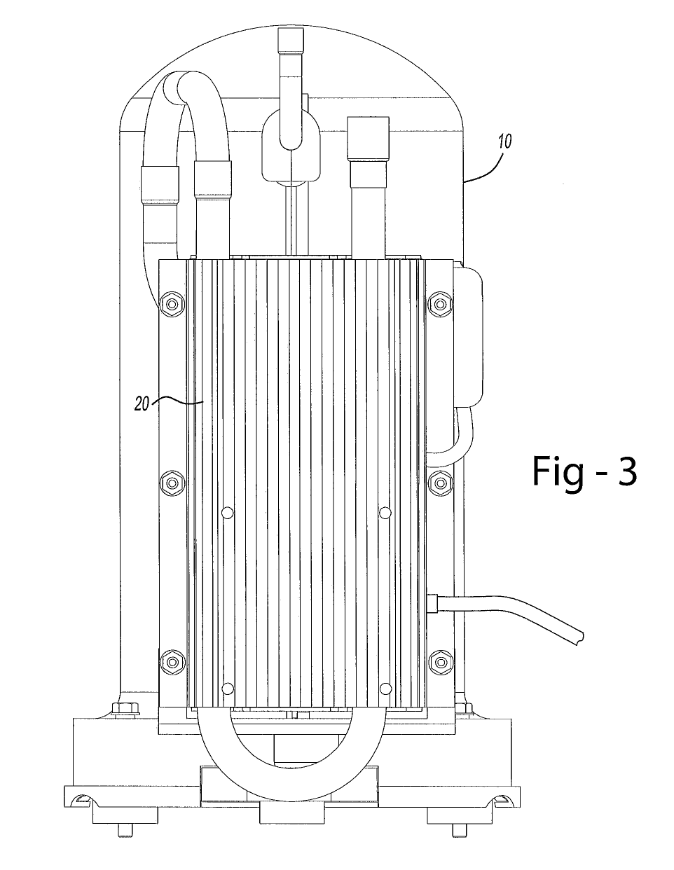

Enclosure 20 may include a cold plate 15 that is cooled by suction refrigerant prior to the suction refrigerant entering compressor 10. Inverter drive 22 may be cooled by suction plate 15 as heat generated by inverter drive 22 is transferred to cold plate 15 and absorbed by suction refrigerant prior to it entering compressor 10. Enclosure 20 and compressor 10 with refrigerant piping through enclosure 20 are shown in FIGS. 2 and 3.

Inverter drive 22 may include a heat sink temperature sensor 45 that generates a signal corresponding to a temperature of inverter 22.

Control module 25 may monitor the temperature of inverter 22 indicated by heat sink temperature sensor 45. When the temperature of inverter 22 exceeds a predetermined threshold, control module 25 may reduce a compressor speed operating range to allow inverter drive 22 to cool.

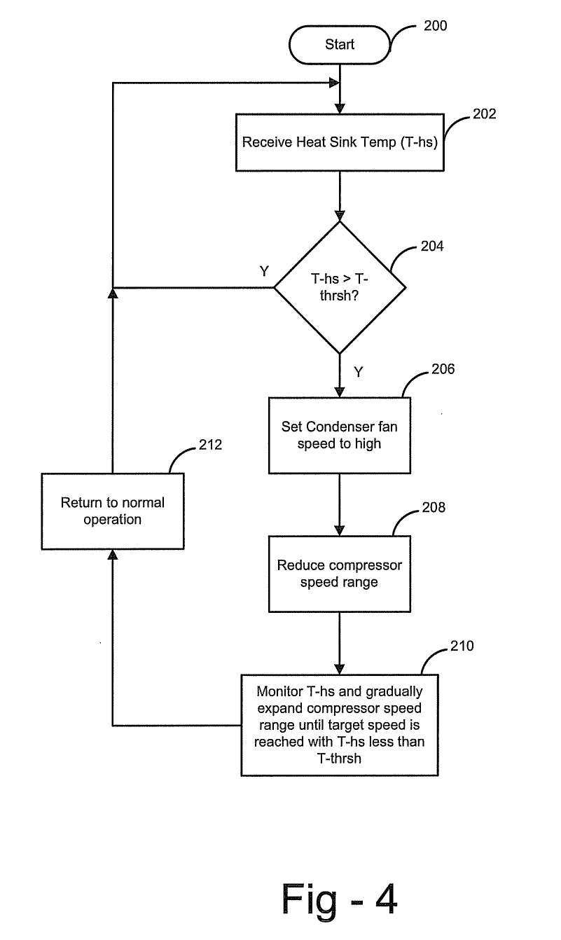

As shown in FIG. 4, a control algorithm according to the present teachings is shown. Control begins in step 200. In step 202, control module 25 may receive a heat sink temperature (T-hs) from heat sink temperature sensor 45. In step 204, control module 25 may determine whether T-hs is greater than the predetermined threshold (T-thrsh). When T-hs is not greater than T-thrsh, control module 25 may return to step 202 and continue to monitor T-hs. When T-hs is greater than T-thrsh, control module 25 may proceed to step 206.

In step 206, control module 25 may set a condenser fan speed to high. As indicated in FIG. 1, control module 25 may control a condenser fan that cools refrigerant in condenser 12. Control module 25 may communicate with a condenser controller to control condenser fan speed. Alternatively, control module 25 may communicate with a refrigeration system controller, or with another system component controller, operable to control condenser fan speed. Control module 25 may increase condenser fan speed to a maximum speed so that a maximum amount of heat is rejected from the refrigeration system.

In step 208, control module 25 may reduce a compressor speed operating range. For example, control module 25 may set the compressor speed to an initial cooling capacity speed. For example, control module 25 may set compressor speed to approximately 2700 RPM.

In step 210, control module 25 may monitor T-sh and gradually expand the compressor speed operating range. As the inverter drive temperature decreases, control module 25 may gradually expand the compressor speed operating range. In this way, control module 25 may insure that inverter drive 22 does not exceed its temperature limit while gradually increasing compressor speed until a target speed is reached. For example, the target speed may be a compressor speed indicated by a refrigeration system controller. Alternatively, the target speed may be generated by control module 25 to achieve a given compressor capacity.

Once control module 25 has attained the target speed while maintaining T-sh below T-thrsh, control module 25 may proceed to step 212 and return to normal operation. In normal operation, condenser fan speed may be set according to a normal operating algorithm. Likewise, compressor speed may be set according to a normal operating algorithm. After step 212, control module 25 may return to step 202.

What is claimed is:

1. A system comprising:
a compressor driven by an inverter drive that modulates a frequency of electric power delivered to said compressor to modulate a speed of said compressor, said inverter drive being cooled by refrigerant and including a temperature sensor that outputs an inverter temperature signal corresponding to an inverter temperature;
a control module that receives said inverter temperature signal, that compares said inverter temperature with a predetermined threshold, and that reduces a compressor operating speed range when said inverter temperature is greater than said predetermined threshold.

2. The system of claim 1 wherein said control module increases a speed of a condenser fan of a condenser connected to said compressor when said inverter temperature is greater than said predetermined threshold.

3. The system of claim 1 wherein said control module, after reducing said compressor operating speed range, increases said compressor operating speed range when said inverter temperature is less than said predetermined threshold.

4. The system of claim 1 wherein said control module reduces said compressor operating speed range to an initial cooling capacity speed when said inverter temperature is greater than said predetermined threshold.

5. The system of claim 1 wherein said control module returns said compressor to normal operation when said inverter temperature returns to a temperature below said predetermined threshold.

6. A method comprising:
modulating a speed of a compressor with an inverter drive that modulates a frequency of electric power delivered to said compressor, said inverter drive being cooled by refrigerant;
receiving an inverter temperature signal corresponding to a temperature of said inverter drive;
comparing said temperature of said inverter drive with a predetermined threshold; and
reducing a compressor operating speed range of said compressor when said temperature is greater than said threshold.

7. The method of claim 6 further comprising increasing a speed of a condenser fan of a condenser connected to said compressor when said temperature of said inverter drive is greater than said threshold.

8. The method of claim 6 further comprising, after said reducing said compressor operating speed range, increasing said compressor operating speed range when said temperature is less than said threshold.

9. The method of claim 6 wherein said reducing said compressor operating speed range includes reducing said compressor operating speed range to an initial cooling capacity speed when said temperature of said inverter drive is greater than said threshold.

10. The method of claim 6 further comprising returning said compressor to normal operation when said temperature of said inverter returns to a temperature below said predetermined threshold.
